(19) United States
(12) Patent Application Publication
(10) Pub. No.: US 2012/0003473 A1
(43) Pub. Date: Jan. 5, 2012

(54) HALOGEN-FREE FLAME-RETARDANT RESIN COMPOSITION, WIRE AND CABLE

(75) Inventors: Kentaro SEGAWA, Hitachi (JP); Kenichiro FUJIMOTO, Hitachi (JP); Katsuhisa SHISHIDO, Hitachinaka (JP); Hiroshi KIMURA, Hitachi (JP); Akira SUZUKI, Hitachi (JP)

(73) Assignee: HITACHI CABLE, LTD., Tokyo (JP)

(21) Appl. No.: 13/176,615

(22) Filed: Jul. 5, 2011

(30) Foreign Application Priority Data
Jul. 5, 2010 (JP) 2010-152760

(51) Int. Cl. B32B 27/18; H01B 3/30; C08K 3/38

(52) U.S. Cl. 428/389; 524/405

(57) ABSTRACT

A halogen-free flame-retardant resin composition includes 100 parts by, weight of base polymer of polyolefin resin, not less than 50 parts by weight and not more than 250 parts by weight of metal hydroxide, not less than 1 part by weight and not more than 50 parts by weight of calcium borate, not less than 1 part by weight and not more than 50 parts by weight of zinc stannate, and less than 30 seconds of burning time after removal of flame in a vertical flame test complying with CODE 895 OR 3^{rd} edition, appendix 6 of the UIC standard.

The present application is based on Japanese Patent Application No. 2010-152760 filed on Jul. 5, 2010, the entire contents of which are incorporated herein by reference.

### BACKGROUND OF THE INVENTION

1. Field of the Invention

The invention relates to a halogen-free flame-retardant resin composition, a wire and a cable, and in particular, to a wire coating halogen-free flame-retardant resin composition, a wire and a cable.

2. Description of the Related Art

The railway is attracting attention as earth-conscious transportation means which consumes less energy and emits less CO₂ relative to the transportation amount. Particularly, a regionally unified standard which is called EN standard (European Norm) is widely adopted in Europe which has the developed railway network. In addition, the organization standard for the railway includes the UIC (Union Internationale des Chemins de fer (in French) or The International Union of Railways (in English)) standard of which criteria for flame-retardant characteristics are higher as compared to that of Japanese domestic standard.

Here, as a flame-retardant resin composition not containing halogen compound, there is a composition of a polyolefin resin and metal hydroxide such as magnesium hydroxide added thereto. Since such a composition does not produce toxic gas such as hydrogen chloride or dioxin when being burnt, it is possible to prevent generation of toxic gas or secondary disaster, etc., in the event of a fire and it is also possible to incinerate for disposal.

Such a composition has a difficulty to realize a highly flame-retardant resin composition which meets the UIC standard required for a rolling stock wire in Europe. In other words, considering tensile characteristics, etc., of wire required by the EN standard. when only the added amount of metal hydroxide is increased, mechanical characteristics such as wire elongation, tensile strength or cold resistance, etc., may significantly decrease in accordance with the increase in the added amount, and thus, desired flame-retardant characteristics are not obtained. Therefore, a flame-retardant aid which allows the added amount of metal hydroxide to be decreased has been continuously studied.

Conventionally, a resin composition is known in which a metal hydrate is used together with a 1,3,5-triazine flame-retardant aid such as melamine cyanurate (see, e.g., JP-A 2010-095638). The resin composition described in JP-A 2010-095638 has a high char-forming effect and is excellent in a flame-retardant effect.

### SUMMARY OF THE INVENTION

In the EN standard focusing on fire safety, reduction in influence on human body in the event that a cable is burnt is required, and low toxicity is also a criterion of judgment. Since the 1,3,5-triazine flame-retardant aid is used in the resin composition according to JP-A 2010-095638, an infinitesimal amount of cyanogen gas may be generated when being burnt even though it is at an acceptable level. Considering the low toxicity aspect, there is still a need to find a method of further decreasing toxicity when being burnt.

Accordingly, it is an object of the invention to provide a halogen-free flame-retardant resin composition that allows a wire to have a flame-retardant effect equivalent to a triazine flame-retardant aid to meet the UIC standard without losing mechanical characteristics such as tensile strength and cold resistance, and without generating toxic gas, as well as a wire and cable using the halogen-free flame-retardant resin composition.

(1) According to one embodiment of the invention, a halogen-free flame-retardant resin composition comprises:

100 parts by weight of base polymer of polyolefin resin;

not less than 50 parts by weight and not more than 250 parts by weight of metal hydroxide;

not less than 1 part by weight and not more than 50 parts by weight of calcium borate;

not less than 1 part by weight and not more than 50 parts by weight of zinc stannate; and

less than 30 seconds of burning time after removal of flame in a vertical flame test complying with CODE 895 OR 3^{rd} edition, appendix 6 of the UIC standard.

In the above embodiment (1) of the invention, the following modifications and changes can be made.

(i) The polyolefin resin comprises ethylene-vinyl acetate copolymer (EVA).

(ii) The metal hydroxide comprises aluminum hydroxide or magnesium hydroxide.

(2) According to another embodiment of the invention, a wire comprises:

an insulation layer comprising as a major component the halogen-free flame-retardant resin composition according to the embodiment (1); and

a conductor coated with the insulation layer.

In the above embodiment (2) of the invention, the following modifications and changes can be made.

(3) According to another embodiment of the invention, a cable comprises:

a sheath comprising as a main component the halogen-free flame-retardant resin

composition according to the embodiment (1); and

a conductor coated with an insulation layer,

wherein the sheath is formed on a periphery of the insulation layer.

In the above embodiments (2) and (3) of the invention, the following modifications and changes can be made.

(iii) The wire or cable further comprises not less than 30% of elongation in a tensile test at −40° C. and at a tension rate of 25 mm/min.

### EFFECTS OF THE INVENTION

One embodiment of the invention can provide a halogen-free flame-retardant resin composition that allows a wire to have a flame-retardant effect equivalent to a triazine flame-retardant aid to meet the UIC standard without losing mechanical characteristics such as tensile strength and cold resistance, and without generating toxic gas, as well as a wire and cable using the halogen-free flame-retardant resin composition.

### BRIEF DESCRIPTION OF THE DRAWINGS

Next, the present invention will be explained in more detail in conjunction with appended drawings, wherein:

FIG. 1 is a cross sectional view showing a wire in a second embodiment of the present invention; and

FIG. 2 is a cross sectional view showing a cable in a third embodiment of the invention.

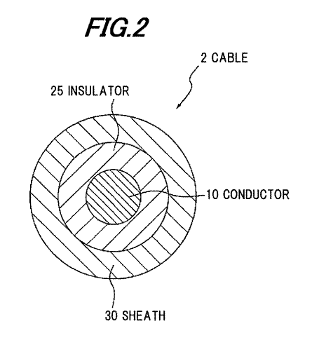

### DETAILED DESCRIPTION OF THE PREFERRED EMBODIMENTS

### First Embodiment

The present inventors combined several types of flame retardants and flame-retardant aids and found a halogen-free flame-retardant resin composition which is provided with all of tensile characteristics and cold resistance of the EN standard and high flame retardance of the UIC standard and also meets the requirement of low toxicity, and a halogen-free flame-retardant resin composition in a first embodiment was thus realized.

In detail, a halogen-free flame-retardant resin composition in the present embodiment is formed by adding metal hydroxide, calcium borate and zinc stannate to a base polymer of polyolefin resin.

As the polyolefin resin, it is possible to use, e.g., low-density polyethylene (LDPE), linear low-density polyethylene (LLDPE), linear very low-density polyethylene (VLDPE), high-density polyethylene (HDPE), ethylene-ethyl acrylate copolymer (EEA), ethylene-vinyl acetate copolymer (EVA), ethylene-styrene copolymer, ethylene-glycidyl methacrylate copolymer, ethylene-butene-1 copolymer, ethylene-butene-hexene terpolymer, ethylene-propylene-diene terpolymer (EPDM), ethylene-octene copolymer (EOR), ethylene copolymerized polypropylene, ethylene-propylene copolymer (EPR), poly(4-methyl-pentene-1), maleic acid grafted low density polyethylene, hydrogenated styrene-butadiene copolymer (H-SBR), maleic acid grafted linear low density polyethylene, a copolymer of ethylene and α-olefin having a carbon number of 4 to 20, maleic acid grafted ethylene methyl acrylate copolymer, maleic acid grafted ethylene vinyl acetate copolymer, ethylene-maleic anhydride copolymer, ethylene-ethyl acrylate-maleic anhydride terpolymer and ethylene-propylene-butene-1 terpolymer consisting mainly of butene-1, etc. These polyolefin resins can be used alone or in combination of two or more thereof. In the present embodiment, it is preferable that ethylene-vinyl acetate copolymer (EVA) be used as the polyolefin resin.

As the metal hydroxide, it is possible to use, e.g., magnesium hydroxide, aluminum hydroxide, calcium hydroxide or a solid solution thereof with nickel. In addition, these metal hydroxides can be surface-treated with a silane coupling agent, a titanate coupling agent, fatty acid such as stearate or calcium stearate, or fatty acid metal salt, etc. The metal hydroxide is added not less than 50 parts by weight per 100 parts by weight of base polymer of polyolefin resin for the purpose of ensuring sufficient flame retardance. Meanwhile, the metal hydroxide is added not more than 250 parts by weight per 100 parts by weight of base polymer of polyolefin resin for the purpose of ensuring mechanical characteristics and cold resistance.

The calcium borate is added not less than 1 part by weight per 100 parts by weight of base polymer of polyolefin resin for the purpose of ensuring sufficient flame retardance. Meanwhile, the calcium borate is added not more than 50 parts by weight per 100 parts by weight of base polymer of polyolefin resin for the purpose of ensuring mechanical characteristics and cold resistance. Then, the zinc stannate is added not less than 1 part by weight per 100 parts by weight of base polymer of polyolefin resin for the purpose of ensuring sufficient flame retardance. Furthermore, the zinc stannate is added not more than 50 parts by weight per 100 parts by weight of base polymer of polyolefin resin for the purpose of ensuring mechanical characteristics and cold resistance.

In the case of adding only the calcium borate to the base polymer, a sufficiently hard char layer may be less likely to be formed when the halogen-free flame-retardant resin composition is burnt, and in the case of adding only the zinc stannate, a heat-insulating layer may not be formed fast enough when the halogen-free flame-retardant resin composition is burnt. Therefore, the metal hydroxide, the calcium borate and the zinc stannate are used together for the halogen-free flame-retardant resin composition in the present embodiment for the purpose of ensuring sufficient flame retardance.

Furthermore, it is possible to appropriately add an additive agent such as a cross-linking agent, a crosslinking aid, a lubricant, a softener, a plasticizer, an ultraviolet absorber, an antioxidant, a filler, a stabilizer, carbon black or a colorant to the halogen-free flame-retardant resin composition in the present embodiment. Meanwhile, chemical cross-linking using organic peroxide or radiation cross-linking by irradiating radiation such as electron beam can be performed on the halogen-free flame-retardant resin composition. In addition, it is possible to add a predetermined amount of flame-retardant aid for the purpose of improving the characteristics of the halogen-free flame-retardant resin composition.

### Effects of the First Embodiment

The halogen-free flame-retardant resin composition in the present embodiment is formed by adding not less than 50 parts by weight and not more than 250 parts by weight of metal hydroxide, not less than 1 part by weight and not more than 50 parts by weight of calcium borate and not less than 1 part by weight and not more than 50 parts by weight of zinc stannate to 100 parts by weight of base polymer of polyolefin resin. Therefore, it is possible to provide a halogen-free flame-retardant resin composition excellent in mechanical characteristics and heat resistance without generating toxic gas such as halogenated gas, phosphine gas and cyanogen gas when being burnt.

### Second Embodiment

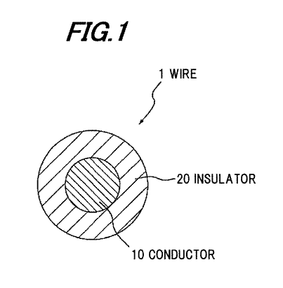

FIG. 1 shows a schematic cross section of a wire in a second embodiment of the invention.

A wire 1 in the second embodiment is mainly composed of a conductor 10 and the halogen-free flame-retardant resin composition explained in the first embodiment, and is also provided with an insulation layer 20 coating the conductor 10. Elongation of the wire 1 in a tensile test at −40° C. and at a tension rate of 25 mm/min is not less than 30%.

### Third Embodiment

FIG. 3 shows a schematic cross section of a cable in a third embodiment of the invention.

A cable 2 in the third embodiment is mainly composed of the conductor 10, an insulation layer 25 coating the conductor 10 and the halogen-free flame-retardant resin composition explained in the first embodiment, and is also provided with a sheath 30 coating the outside of the insulation layer 25. Elongation of the cable 2 in a tensile test at −40° C. and at a tension rate of 25 mm/min is not less than 30%.

### EXAMPLES

In Examples, a wire coating halogen-free flame-retardant resin composition and a wire using the halogen-free flame-retardant resin composition were made. In detail, various compounds, etc., were compounded at a compounding ratio shown in Table 1 and were kneaded using a pressure kneader at a start temperature of 40° C. and an end temperature of 180° C., thereby obtaining a kneaded product. Next, the kneaded product was molded into a pellet shape and the pellet was continuously vulcanized and extruded on an outer periphery of a conductor at a preset temperature of 110° C. so that a thickness of the coating is 0.7 mm, thereby making a wire.

Tensile Test

A tensile test was conducted on the obtained wires in accordance with EN 60811-1-1. The wires with tensile strength of less than 10 MPa are judged as “X” (failed) and the wires with tensile strength of not less than 10 MPa are judged as “O” (passed). The wire with elongation of less than 150% are judged as “X” (failed) and the wires with elongation of not less than 150% are judged as “O” (passed).

Flame-Retardant Test

A vertical flame test was conducted on the obtained wires in accordance with

CODE 895 OR 3^{rd} edition, appendix 6 of the UIC standard. For evaluation, the wires with burning time of not less than 30 seconds after removal of flame are judged as “X” (failed) and the wires with burning time of less than 30 seconds are judged as “O” (passed).

Low-Temperature Tensile Test

A tensile test was conducted on the obtained wires at −40° C. in accordance with EN 60811-1-4. The wires with elongation of less than 30% are judged as “X” (failed) and those with elongation of not less than 30% are judged as “O” (passed).

Table 1 shows compounding ingredients in the halogen-free flame-retardant resin composition used for the wires in Examples 1 to 13, the compounding ratio thereof and characteristics of the wires.

TABLE 1

| | | | | Examples: compounding amount (parts by weight) | | | | | | | | | | | | |
|---|---|---|---|---|---|---|---|---|---|---|---|---|---|---|---|---|
| | Functions | Materials | | 1 | 2 | 3 | 4 | 5 | 6 | 7 | 8 | 9 | 10 | 11 | 12 | 13 |
| Compounding | Polymer | EVA*¹ | | 100 | | | | | 100 | 100 | 100 | 100 | 80 | 70 | 80 | 70 |
| ingredient | | EVA*² | | | 100 | | | | | | | | 20 | 30 | 20 | 30 |
| | | EVA*³ | | | | 100 | | | | | | | | | | |
| | | VLDPE*⁴ | | | | | 100 | | | | | | | | | |
| | | EEA*⁵ | | | | | | 100 | | | | | | | | |
| | Flame retardant | Magnesium | | 150 | 150 | 150 | 150 | 150 | 50 | 250 | 150 | 150 | 150 | 150 | | |
| | | hydroxide*⁶ | | | | | | | | | | | | | | |
| | | Aluminum | | | | | | | | | | | | | 150 | 150 |
| | | hydroxide*⁷ | | | | | | | | | | | | | | |
| | Flame retardant | Calcium borate*⁸ | | 10 | 10 | 10 | 10 | 10 | 10 | 10 | 1 | 50 | 10 | 10 | 10 | 10 |
| | aid | Zinc stannate*⁹ | | 10 | 10 | 10 | 10 | 10 | 10 | 10 | 1 | 50 | 10 | 10 | 10 | 10 |
| | Cross-linking | Peroxide*¹⁰ | | 1.5 | 1.5 | 1.5 | 1.5 | 1.5 | 1.5 | 1.5 | 1.5 | 1.5 | 1.5 | 1.5 | 1.5 | 1.5 |
| | agent | | | | | | | | | | | | | | | |
| | Antioxidant | Antioxidant A*¹¹ | | 3 | 3 | 3 | 3 | 3 | 3 | 3 | 3 | 3 | 3 | 3 | 3 | 3 |
| | Lubricant | Zinc stearate*¹² | | 1 | 1 | 1 | 1 | 1 | 1 | 1 | 1 | 1 | 1 | 1 | 1 | 1 |
| | Colorant | Carbon black*¹³ | | 2 | 2 | 2 | 2 | 2 | 2 | 2 | 2 | 2 | 2 | 2 | 2 | 2 |
| Characteristics | Tensile | Tensile | Target: | ◯ | ◯ | ◯ | ◯ | ◯ | ◯ | ◯ | ◯ | ◯ | ◯ | ◯ | ◯ | ◯ |
| | characteristics | strength | not less | 11.2 | 13.5 | 17.8 | 16.0 | 14.9 | 11.1 | 10.4 | 11.2 | 10.3 | 11.4 | 11.5 | 12.0 | 12.2 |
| | | (MPa) | than 10 | | | | | | | | | | | | | |
| | | Elongation | Target: | ◯ | ◯ | ◯ | ◯ | ◯ | ◯ | ◯ | ◯ | ◯ | ◯ | ◯ | ◯ | ◯ |
| | | (%) | not less | 427 | 274 | 160 | 248 | 184 | 603 | 150 | 483 | 150 | 393 | 375 | 351 | 337 |
| | | | than 150 | | | | | | | | | | | | | |
| | Flame | Flame test | Target: | 15 | 17 | 25 | 26 | 25 | 29 | 4 | 29 | 11 | 15 | 16 | 18 | 19 |
| | retardance | | less than | | | | | | | | | | | | | |
| | | | 30 | | | | | | | | | | | | | |
| | Cold resistance | Elongation | Target: | ◯ | ◯ | ◯ | ◯ | ◯ | ◯ | ◯ | ◯ | ◯ | ◯ | ◯ | ◯ | ◯ |
| | | (%) | not less | 37 | 35 | 62 | 120 | 77 | 43 | 30 | 40 | 30 | 37 | 36 | 40 | 43 |
| | | | than 30 | | | | | | | | | | | | | |

| | | | | | | | | | | | | | |
|---|---|---|---|---|---|---|---|---|---|---|---|---|---|
| Evaluation | ◯ | ◯ | ◯ | ◯ | ◯ | ◯ | ◯ | ◯ | ◯ | ◯ | ◯ | ◯ | ◯ |

*¹Evaflex 45XL, manufactured by Mitsui DuPont Polychemical Co. Ltd
*²Evaflex V9000, manufactured by Mitsui DuPont Polychemical Co. Ltd
*³Evaflex V987, manufactured by Mitsui DuPont Polychemical Co. Ltd
*⁴EXCELLEN VL100, manufactured by Sumitomo Chemical Co., Ltd.
*⁵Rexpearl A1150, manufactured by Japan Polyethylene Corporation
*⁶Kisuma 5L, manufactured by Kyowa Chemical Industry Co. Ltd.
*⁷BF013TV, manufactured by Nippon Light Metal Co., Ltd.
*⁸UBP, 5μ, manufactured by Kinsei Matec Co., Ltd.
*⁹Alcanex ZHS, manufactured by Mizusawa Industrial Chemicals Ltd.
*¹⁰Perkadox 14SFL, manufactured by Kayaku Akzo Corporation
*¹¹NOCRAC 224, manufactured by Ouchi-Shinko Chemical Industrial Co. Ltd.
*¹²EZ101, manufactured by Eishin Kasei Co., Ltd.
*¹³Asahi Thermal FT, manufactured by Asahi Carbon Co., Ltd.

Meanwhile, the Table 2 shows compounding ingredients in the halogen-free flame-retardant resin composition used for the wires in Comparative Examples 1 to 8, the compounding ratio thereof and characteristics of the wires. The wires in Comparative Examples 1 to 8 were made in the same manner as Examples.

TABLE 2

| | | | | Comparative Examples: compounding amount | | | | | | | |
|---|---|---|---|---|---|---|---|---|---|---|---|
| | | | | (parts by weight) | | | | | | | |
| | Functions | Materials | | 1 | 2 | 3 | 4 | 5 | 6 | 7 | 8 |
| Compounding | Polymer | EVA | | 100 | 100 | 100 | 100 | 100 | 100 | 100 | 100 |
| ingredient | Flame retardant | Magnesium hydroxide | | 48 | 255 | 150 | 150 | 150 | 150 | 150 | 150 |
| | Flame retardant | Calcium borate | | 10 | 10 | 50 | 50 | 0.9 | 51 | 0 | 10 |
| | aid | Zinc stannate | | 10 | 10 | 0.9 | 51 | 50 | 50 | 10 | 0 |
| | | zinc borate | | 0 | 0 | 0 | 0 | 0 | 0 | 10 | 0 |
| | Cross-linking | Peroxide | | 1.5 | 1.5 | 1.5 | 1.5 | 1.5 | 1.5 | 1.5 | 1.5 |
| | agent | | | | | | | | | | |
| | Antioxidant | Antioxidant A | | 3 | 3 | 3 | 3 | 3 | 3 | 3 | 3 |
| | Lubricant | Zinc stearate | | 1 | 1 | 1 | 1 | 1 | 1 | 1 | 1 |
| | Colorant | Carbon black | | 2 | 2 | 2 | 2 | 2 | 2 | 2 | 2 |
| Characteristics | Tensile | Tensile strength | Target: not less than | ◯ | X | ◯ | ◯ | ◯ | ◯ | ◯ | ◯ |
| | characteristics | (MPa) | 10 | 11.3 | 9.8 | 10.5 | 10.2 | 10.6 | 10.3 | 10.2 | 10.1 |
| | | Elongation (%) | Target: not less than | ◯ | X | ◯ | X | ◯ | X | ◯ | ◯ |
| | | | 150 | 607 | 148 | 423 | 149 | 441 | 148 | 150 | 153 |
| | Flame | Flame test | Target: less than 30 | 31 | 3 | 31 | 12 | 31 | 11 | 31 | 32 |
| | retardance | | | | | | | | | | |
| | Cold resistance | Elongation (%) | Target: not less than | ◯ | X | ◯ | X | ◯ | X | ◯ | ◯ |
| | | | 30 | 45 | 28 | 35 | 29 | 35 | 28 | 35 | 33 |

| | | | | | | | | |
|---|---|---|---|---|---|---|---|---|
| Evaluation | X | X | X | X | X | X | X | X |

The wires in Examples 1 to 13 passed all tests of the tensile strength, the elongation and the vertical flame test and also satisfied the target of the low-temperature tensile characteristics, and thus exhibit satisfactory characteristics. In addition, since the wires in Examples 1 to 13 do not contain a triazine flame-retardant aid, it was possible to ensure low toxicity.

The wire in Comparative Example 1 does not have sufficient flame retardance since the added amount of the magnesium hydroxide was 48 parts by weight which is out of the range of not less than 50 parts by weight. Meanwhile, the wire in Comparative Example 2 does not have sufficient tensile characteristics and low-temperature tensile characteristics since the added amount of the magnesium hydroxide was 255 parts by weight which is out of the range of not more than 250 parts by weight.

The wire in Comparative Example 3 does not have sufficient flame retardance since the added amount of the zinc stannate was 0.9 parts by weight which is out of the range of not less than 1 part by weight. Meanwhile, the wire in Comparative Example 4 does not have sufficient tensile characteristics and low-temperature tensile characteristics since the added amount of the zinc stannate was 51 parts by weight which is out of the range of not more than 50 parts by weight.

The wire in Comparative Example 5 does not have sufficient flame retardance since the added amount of the calcium borate was 0.9 parts by weight which is out of the range of not less than 1 part by weight. Meanwhile, the wire in Comparative Example 6 does not have sufficient tensile characteristics and low-temperature tensile characteristics since the added amount of the calcium borate was 51 parts by weight which is out of the range of not more than 50 parts by weight. Furthermore, the wire in Comparative Example 7 does not have sufficient flame retardance since calcium borate is not added even though 10 parts by weight of zinc stannate and 10 parts by weight of zinc borate are added. The wire in Comparative Example 8 does not have sufficient flame retardance since zinc stannate is not added even though 10 parts by weight of calcium borate is added.

Although the embodiments and examples of the invention have been described, the invention according to claims is not to be limited to the above-mentioned embodiments and examples. Further, please note that not all combinations of the features described in the embodiments and examples are not necessary to solve the problem of the invention.

What is claimed is:

1. A halogen-free flame-retardant resin composition, comprising:
100 parts by weight of base polymer of polyolefin resin;
not less than 50 parts by weight and not more than 250 parts by weight of metal hydroxide;
not less than 1 part by weight and not more than 50 parts by weight of calcium borate;
not less than 1 part by weight and not more than 50 parts by weight of zinc stannate; and
less than 30 seconds of burning time after removal of flame in a vertical flame test complying with CODE 895 OR 3^{rd} edition, appendix 6 of the UIC standard.

2. The halogen-free flame-retardant resin composition according to claim 1, wherein the polyolefin resin comprises ethylene-vinyl acetate copolymer (EVA).

3. The halogen-free flame-retardant resin composition according to claim 1, wherein the metal hydroxide comprises aluminum hydroxide or magnesium hydroxide.

4. A wire, comprising:
an insulation layer comprising as a major component the halogen-free flame-retardant resin composition according to claim 1; and
a conductor coated with the insulation layer.

5. The wire according to claim 4, further comprising not less than 30% of elongation in a tensile test at −40° C. and at a tension rate of 25 mm/min.

6. A cable, comprising:
a sheath comprising as a main component the halogen-free flame-retardant resin composition according to claim 1; and
a conductor coated with an insulation layer,
wherein the sheath is formed on a periphery of the insulation layer.

7. The cable according to claim 6, further comprising not less than 30% of elongation in a tensile test at −40° C. and at a tension rate of 25 mm/min.
